(19) United States
(12) Patent Application Publication
(10) Pub. No.: US 2017/0247204 A1
(43) Pub. Date: Aug. 31, 2017

(54) MATERIAL TRANSFER STATION

(71) Applicant: EHS Solutions LLC, Peoria, IL (US)

(72) Inventors: Tim Schwind, Eureka, IL (US); Robert Herrmann, Princeville, IL (US); Galen Rocke, Pekin, IL (US)

(21) Appl. No.: 15/511,773

(22) PCT Filed: Sep. 16, 2015
(86) PCT No.: PCT/US15/50445

§ 371 Date: Mar. 16, 2017

Related U.S. Application Data
(60) Provisional application No. 62/050,849, filed on Sep. 16, 2014.

(51) Int. Cl. B65G 65/23; B25J 21/02; B65G 69/18; B65B 1/08; B65B 31/00

(52) U.S. Cl. CPC B65G 65/23; B65B 1/08; B65B 31/00; B65G 69/181; B25J 21/02

(57) ABSTRACT

According to embodiments of the present invention, a material transfer station provides a base frame equipped with a table member, a container tipper, an operator interface, and a connection to a power source. In operation, a destination container is positioned beneath the table member, and the container tipper holds a supply container. Solid matter may be conveyed from the supply container into the destination container through an opening in the table member. Modules may be attached to provide additional functionality, such as a receiving module, a containment module, a vibratory screener, a flexible film isolator, and a nitrogen purge system.

### CROSS-REFERENCE TO RELATED APPLICATIONS

The present application claims the benefit of U.S. Provisional Patent Application No. 62/050,849, filed Sep. 16, 2014, the content of which is hereby incorporated by reference in its entirety.

### BACKGROUND OF THE INVENTION

In the manufacturing of chemical compounds in fields including the pharmaceuticals industry, raw solid materials are allocated into batch quantities by transfer from bulk storage containers, such as drums and bags, to standard containers. The conveyance of solid materials from bulk storage containers into standard containers presents challenges due to the weight of the materials to be transferred, containment of spillage, fumes, and vapors, and guiding the conveyance of materials between differently-shaped containers.

Transfer systems provide mechanical frames which support flexible film isolators and glove bags for conveying materials from a drum into process equipment. The DoverPac system, manufactured by ILC Dover of the United States, provides a lifter which elevates a drum and an enclosure which supports a sleeve. The sleeve has an opening that is attached to the drum and an inner liner that attaches to process equipment, allowing the contents of the drum to be passed through the sleeve and into the process equipment while isolated from the outside. The sleeve is provided with built-in gloves that reach into the interior of the sleeve so that the contents of the drum can be manipulated.

The functionality of existing transfer systems is limited to supporting a flexible film isolator and elevating a drum; other functionality is not contemplated. The enclosure and the lifter are separate elements, must be configured manually on a case-by-case basis, and power must be supplied separately. The configuration of the enclosure in conjunction with the lifter and process equipment is often laborious, and if the operator wishes to add other mechanical, powered elements to provide additional functions, this will result in space-consuming, ad-hoc arrangements. Further improvements to such a system are desirable.

### BRIEF SUMMARY OF THE INVENTION

According to embodiments of the present invention, a material transfer station provides a base frame equipped with a table member and a powered container tipper. In operation, a destination container is positioned beneath the table member, and the container tipper holds a supply container. Solid matter may be conveyed from the supply container into the destination container through an opening in the table member. As solid matter falls through the conveyance passage, particulate matter may become airborne from the falling particulate stream. To contain the falling particulate matter, embodiments of the present invention provide an open transfer configuration wherein a containment module provides ventilation about the stream of falling particulate, and a high containment configuration wherein a flexible film isolator establishes a closed space about the stream of falling particulate.

According to embodiments of the present invention, a power source may be attached to a control box of the base frame to supply power to powered components and modules of the base frame. An operator interface may send signals to powered components and modules of the base frame. The container tipper may enable the supply container to be uptilted and moved over an opening guiding falling particulate matter into the destination container. A receiving module may be attached to the base frame to receive the destination container and provide a load cell to weigh the contents of the destination container. A containment module provides several embodiments establishing a passage into the destination container. A vibratory screener may be interposed within the stream of falling particulate. A flexible film isolator may provide a glove bag having a handling member and a filter port receiving a connection to a nitrogen purge system, and may provide ports connecting to the supply container and the destination container.

Embodiments of the present invention further provide open and closed transfer methods for operating the material transfer station.

### BRIEF DESCRIPTION OF THE DRAWINGS

FIGS. 1A through 1C illustrate elevation views of a base frame of a material transfer station according to embodiments of the present invention.

FIG. 2A illustrates a perspective view of a base frame of a material transfer station according to an embodiment of the present invention. FIG. 2B illustrates a perspective view of a base frame of a material transfer station assembled in conjunction with a receiving module providing a load cell according to an embodiment of the present invention.

FIG. 3A illustrates a perspective view of a base frame of a material transfer station assembled in conjunction with a flexible isolator module according to an embodiment of the present invention. FIG. 3B illustrates a perspective view of a base frame of a material transfer station assembled in conjunction with a flexible isolator module and a receiving module providing a load cell according to an embodiment of the present invention.

FIGS. 4A through 4E illustrate perspective views of containment modules according to embodiments of the present invention.

FIGS. 5A through 5D illustrate perspective, overhead, front elevation, and side elevation views of a material transfer station assembled in conjunction with a receiving module according to an embodiment of the present invention.

FIGS. 6A through 6D illustrate perspective, overhead, front elevation, and side elevation views of a material transfer station assembled in conjunction with a receiving module and a flexible isolator module according to an embodiment of the present invention.

FIGS. 7A through 7D illustrate perspective, overhead, front elevation, and side elevation views of a material transfer station assembled in conjunction with a receiving module, a split valve containment module, and a flexible isolator module according to an embodiment of the present invention.

FIG. 8 illustrates the installation of a containment module according to an embodiment of the present invention.

FIG. 9 illustrates the setup of a material transfer station according to an embodiment of the present invention.

FIG. 10 illustrates the setup of a material transfer station assembled in conjunction with a flexible isolator module according to an embodiment of the present invention.

FIG. 11 illustrates the operation of a container tipper of a material transfer station assembled in conjunction with a flexible isolator module according to an embodiment of the present invention.

FIG. 12 illustrates the operation of a container tipper of a material transfer station assembled without a flexible isolator module according to an embodiment of the present invention.

FIGS. 13A and 13B illustrate disassembly steps of a material transfer station according to an embodiment of the present invention.

FIGS. 14 through 16 illustrate perspective views of a material transfer station according to an embodiment of the present invention.

FIGS. 17A through 17D illustrate the setup of a side table providing an isolator frame extension according to an embodiment of the present invention.

### DETAILED DESCRIPTION OF THE INVENTION

Embodiments of the present invention provide a material transfer station that incorporates a base frame having a table and a powered container tipper which, together, are operable to convey dry or wet solid matter from a supply container to a destination container. A material transfer station according to embodiments of the present invention, furthermore, provides attachable modules providing additional functionality. Thus, further embodiments of the present invention provide multiple configurations of a material transfer station system which include various combinations of modules that provide functions such as particulate containment and weighing.

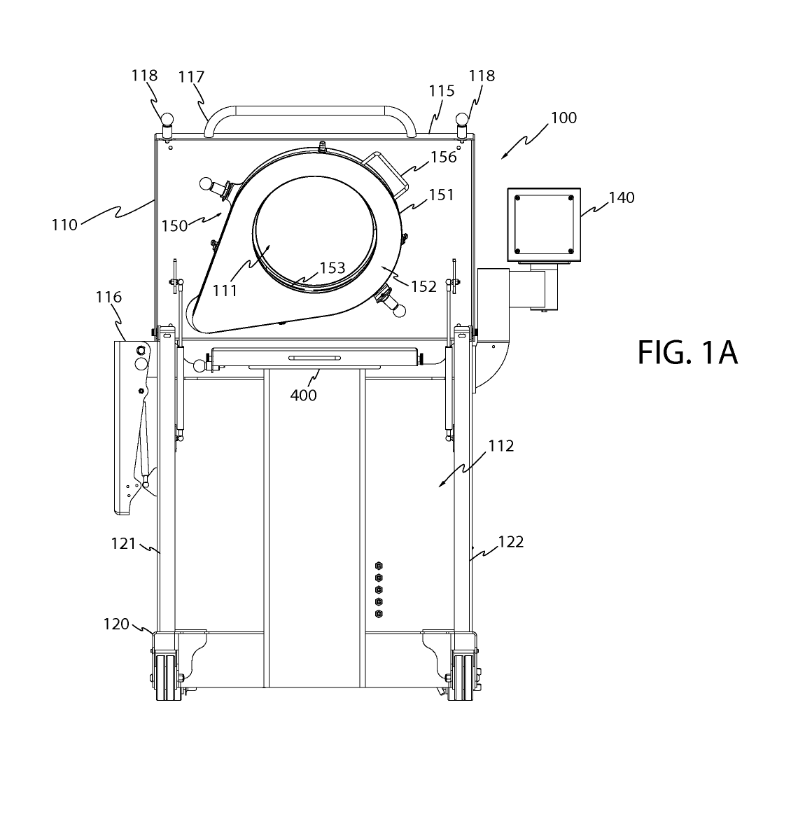

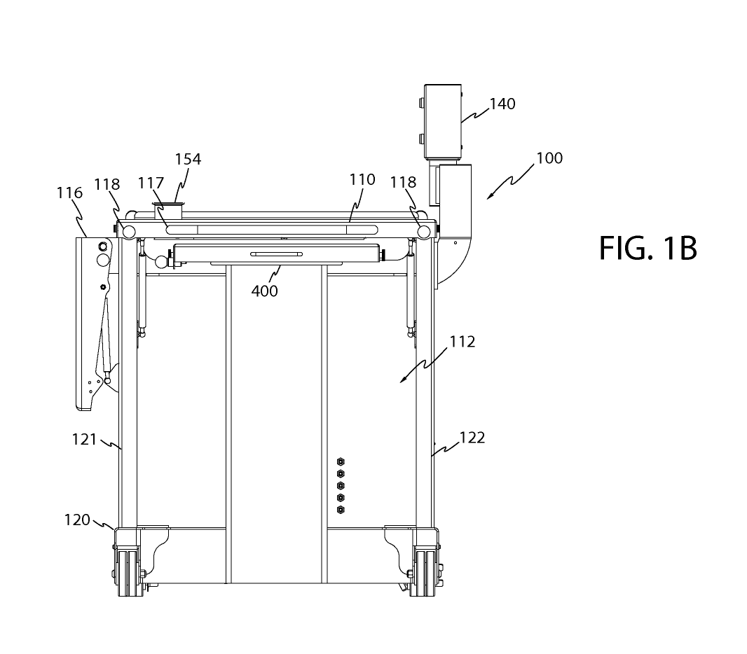

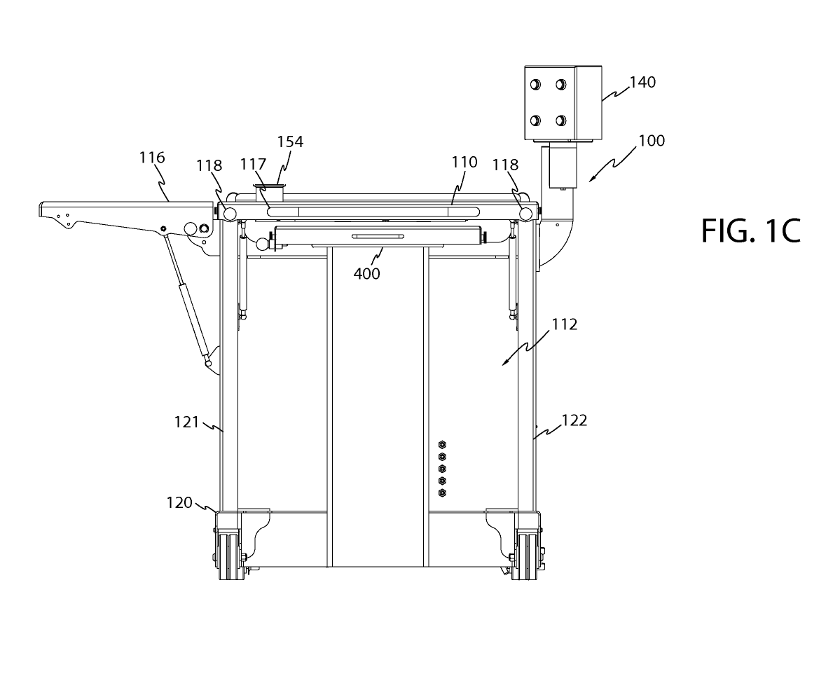

FIGS. 1A, 1B, and 1C illustrate elevation views of a base frame 100 according to an embodiment of the present invention. The elevation views of FIGS. 1A, 1B, and 1C illustrate a frontal orientation of the base frame 100. Throughout this description, positional terms such as “front,” “rear,” and “side” refer to the base frame and all modules attached to the base frame as viewed from this frontal orientation. The base frame 100 is composed of a table member 110, a base member 120, a control box 130, and an operator interface 140.

A table member 110 according to embodiments of the present invention provides an opening 111 through the table member 110. The table member 110 has a front edge 115. The table member 110 is suspended over a clearance 112 by a first riser 121 and a second riser 122 of the base member 120. The opening 111 opens over the clearance 112. The underside of the table member 110 is pivotably hinged to the first riser 121 and the second riser 122. A handle 117 may be attached to the front edge 115 of the table member 110. The front edge 115 of the table member 110 may be releasably fastened to the first riser 121 and the second riser 122 by fasteners 118, such as pull pins. While the front edge 115 of the table member 110 is released from the first riser 121 and the second riser 122, the table member 110 may be raised to an upright orientation or lowered to a level orientation. A secondary opening through the table member 110 may allow an exhaust port 154 of a ventilation sleeve 150 to pass through when a ventilation sleeve 150 is installed as described herein. The secondary opening may open through a top face of the table member 110 or a lateral face of the table member 110, depending on the orientation of the exhaust port 154.

Embodiments of the present invention may further provide the base frame 100 with a side table 116. The side table 116 may be pivotably hinged by an edge of the side table 116 to a side of the first riser 121 or to a side of the second riser 122. The side table 116 may be adapted to pivot between a level orientation and a lowered orientation. In either orientation, the side table 116 may be secured in place by releasable fasteners such as pull pins. The releasable fasteners may be released to allow the side table 116 to pivot between orientations. The pivoting of the side table 116 may be supported by an actuator such as a gas spring.

A base member 120 according to embodiments of the present invention contacts the base frame 100 with a ground surface. A base member 120 may be a stationary installation base member or a mobile installation base member. A stationary installation base member 120 may contact a ground surface by an affixable member. A mobile installation base member 120 may contact a ground surface by a lateral translation member; a mobile installation base member 120 may further be provided with a releasably engageable locking member, where the locking member fixes the mobile installation base member 120 to the ground surface while engaged. For example, a lateral translation member may be a caster, where a locking member may be a brake mechanism prohibiting lateral movement of the caster while engaged, and allowing lateral movement of the caster while disengaged.

A control box 130 may provide an operation switch, a power input connection, a control circuit, and a power output connection. The power input connection and the power output connection are each in connection to the control circuit. The power input connection may receive a flow connection from a power source, which may be a fluid power source such as a pneumatic power generator or an electric-hydraulic power generator. The operation switch may control flow from the fluid power source to the power input connection. The operation switch may be set to an operation mode allowing flow from the power source to the power input connection. The operation switch may be set to a maintenance mode allowing drainage from the control box 130 connections. The operation switch may be set to a shutdown mode cutting off flow from the power source to the power input connection. A control box 130 may provide a connection to the control circuit and a connection to the power output connection. The power output connection may be placed in connection with a powered component of the base frame 100 or a powered module attached to the base frame 100 so as to supply power from the power source to the powered component or powered module.

An operator interface 140 may provide a human interface device in electrical connection with the control circuit. A human interface device may include a control which may be manipulated by a human operator to send a command signal through the control circuit to a powered component of the base frame 100 or powered module attached to the base frame 100 or to send a data signal to a memory; may include a memory which receives a data signal sent by a control and records the data signal as a data record; and may include a visual display which receives a display signal from the control circuit and represents the display signal as visual information. A control may be a push button, an analog instrument, a touchscreen, or any other suitable interface device known in the art. A visual display may be any suitable electronic display device known in the art. An operator interface may be mounted to the base frame 100 by a pivotable member configured to face the human interface device in several orientations. For example, the operator interface 140 may be laterally turned to face the human interface device in a frontal, side, or rearward direction.

A ventilation sleeve 150 may be fastened to the underside of the table member 110. The ventilation sleeve 150 provides an annular frame 151 housing a flow chamber 152 connected to an exhaust port 154. The exhaust port 154 may have an upright orientation or a lateral orientation. The annular frame 151 may be fastened to the underside of the opening 111 of the table member 110. The annular frame 151 may be provided with handles 156 attached to the upper edge of the annular frame 151.

The inward-facing circumferential wall of the annular frame 151 is perforated substantially about the circumference of the annular frame 151 with ventilation slots 153. Ventilation slots 153 access the flow chamber 152 in connection with the exhaust port 154. According to embodiments of the present invention, the annular frame 151 may encircle a full perimeter of the opening 111, such that ventilation slots are provided substantially about the full perimeter of the opening 111.

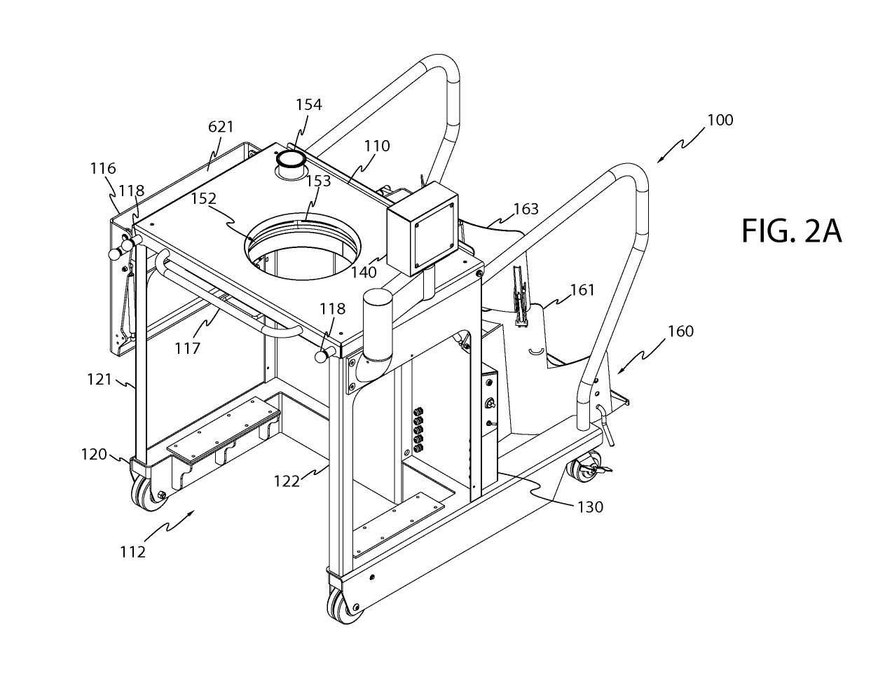

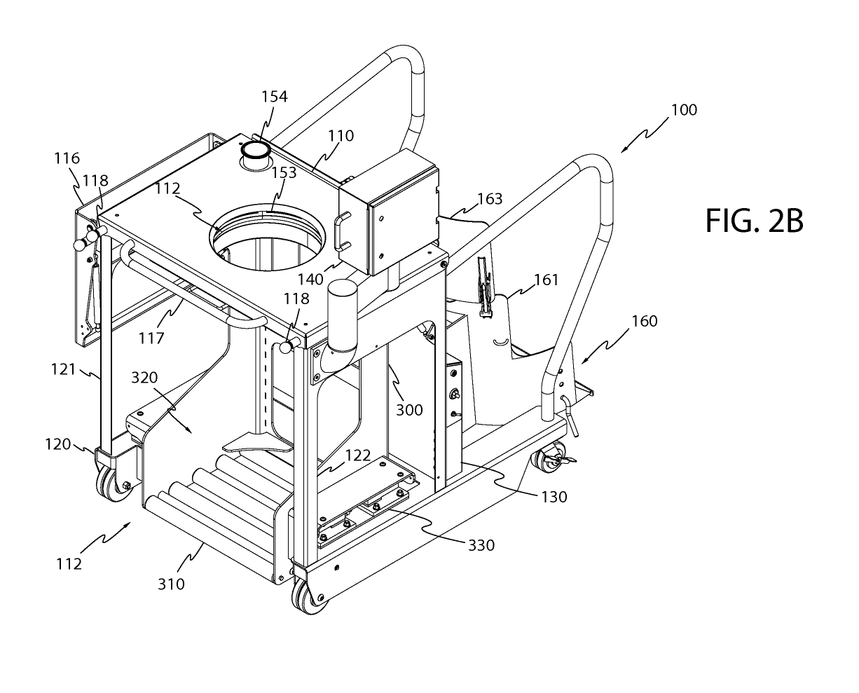

FIGS. 2A and 2B illustrate perspective views of a base frame 100. A container tipper 160 may be integrally secured to the rear of the base frame 100 according to an embodiment of the present invention. A container tipper 160 in accordance with embodiments of the present invention may be a powered system which lifts a supply container containing solid matter, and tilts the supply container to convey the solid matter out of the supply container.

A container tipper 160 provides a cradle 161, a powered actuator 165, and a secondary actuator 166. The cradle 161 may provide a support surface configured to hold a supply container. The cradle 161 may be mounted to a pivoting arm 164, the top of the pivoting arm 164 being pivotably hinged to the container tipper 160. A mechanical stop 167 may be positioned under the pivoting arm 164, and may be releasably engageable to hold the pivoting arm 164 in place. The cradle 161 may be slidable along a length of the pivoting arm 164. The powered actuator 165 and the secondary actuator 166 may be powered cylinders. The powered actuator 165 may have a piston configured to shift the cradle 161 from an upright position to an uptilted position by elevating the pivoting arm 164, or to shift the cradle 161 from an uptilted position to an upright position by lowering the pivoting arm 164. The secondary actuator 166 may have a piston configured to slide the cradle 161 in a topward direction along the pivoting arm 164, or to shift the cradle 161 in a bottomward direction along the pivoting arm 164. The powered actuator 165 and the secondary actuator 166 may each be in connection to the control circuit of the control box 130 so as to draw power from the power source. A restraint 162 may be releasably secured laterally across the cradle 161 at a first side and a second side of the cradle 161 such that while the cradle 161 holds a supply container, the restraint 162 may secure the supply container to the cradle 161. A cradle extension 163 may be attached to the top end of the cradle 161 to extend the support surface provided by the cradle 161 for receiving a supply container.

The human interface device of the operator interface 140 may provide a control manipulable by a human operator to send a command signal through the control circuit to the powered actuator 165 to cause the powered actuator 165 to raise the pivoting arm 164 or to lower the pivoting arm 164, or to the secondary actuator 166 to cause the secondary actuator 166 to slide the cradle 161 in a topward direction or a bottomward direction along the pivoting arm 164.

A receiving module 300 may be attached to the base frame 100 within the clearance 112 beneath the table member 110. A receiving module 300 according to embodiments of the present invention may provide a roller conveyor 310 and an enclosure 320. The receiving module 300 may hold a destination container such that the destination container is removed from a ground surface, and the roller conveyer 310 may facilitate the placement of the destination container within the receiving module 300. The enclosure 320 may be attached to the base frame 100 by mounting members such as side brackets as illustrated in FIG. 2B.

According to embodiments of the present invention as illustrated in FIG. 2B, a receiving module 300 may further provide a load cell 330. A load cell 330 may be attached to the base frame 100 and to the receiving module 300, and may operate by load cell mechanisms known in the art to measure a force exerted by the receiving module 300 and any objects held by the receiving module 300, and translate the measured force to a weight measurement. The load cell 330 may be in electrical connection with the power output connection so as to draw power from the power source, and in electrical connection with the control circuit of the control box 130. The load cell 330 may convert the weight measurement translated from the measured force to a measurement electrical signal and transmit the measurement electrical signal to the control circuit. The control circuit may convert the measurement electrical signal received from the load cell 330 to a weight measurement value, and may transmit a display signal to the operator interface 140 causing the operator interface 140 to display the weight measurement value. The combination of the load cell 330 in electrical connection with the control circuit may be referred to as a weighing system.

The human interface device of the operator interface 140 may provide a control manipulable by a human operator to send a command signal through the control circuit to the load cell 330 to cause the load cell 330 to turn on, set a tare weight, record a measured weight in memory, and perform other load cell functions known in the art.

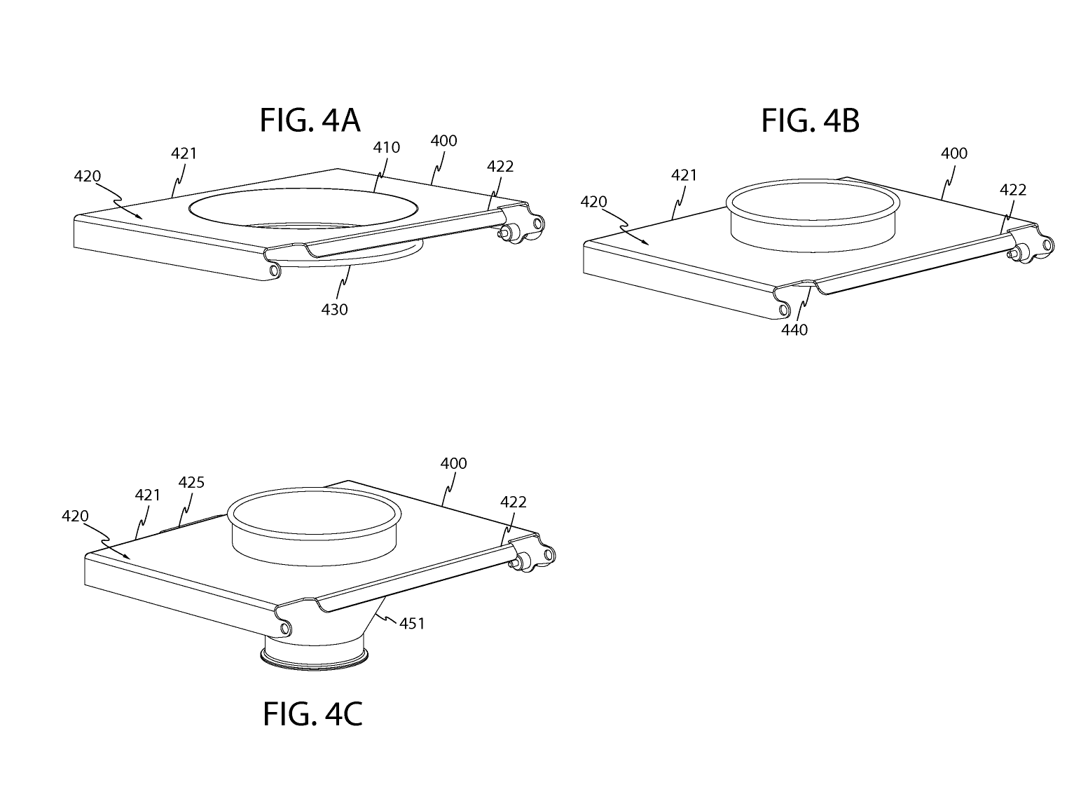

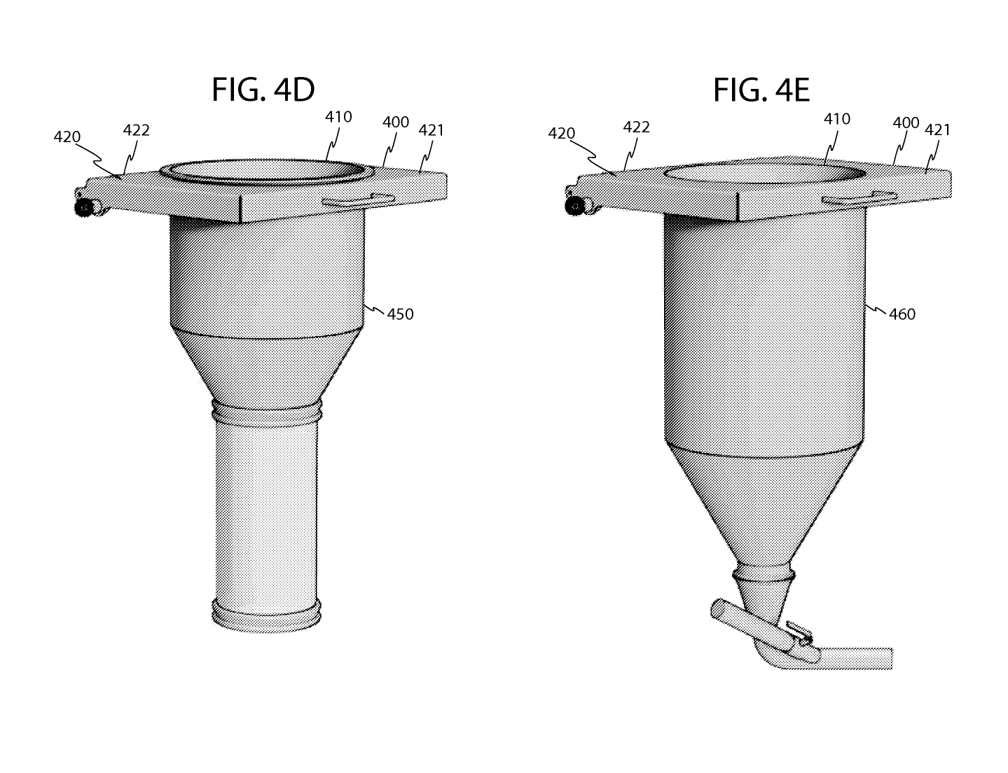

Embodiments of the present invention may further provide the base frame 100 with a containment module 400 as illustrated in FIGS. 4A through 4E. A containment module 400 according to embodiments of the present invention provides a module opening 410 through a module surface member 420. The module surface member 420 has a front edge 421 and a back edge 422. A handle 425 may be attached to the front edge 421 of the module surface member 420. The back edge 422 may be removably attached to the base frame 100 beneath the table member 110 such that the module surface member 420 is suspended over the clearance 112 by the base frame 100. The back edge 422 of the module surface member 420 may be releasably and pivotably secured to the base frame 100 by fasteners. The containment module 400 may be raised to an upright position or lowered to a level position by pivoting about the back edge 422.

According to embodiments of the present invention as illustrated in FIG. 4A, a containment module 400 may be an open transfer containment module. According to an open transfer containment module embodiment of the present invention, a lower ring 430 encircles the module opening 410 at the underside of the module surface member 420.

According to embodiments of the present invention as illustrated in FIG. 4B, a containment module 400 may be a continuous liner containment module. According to a continuous liner containment module embodiment of the present invention, a continuous liner system 440 is secured through the module opening 410 of the module surface member 420. A film tube magazine 441 may be loaded onto the continuous liner system 440, where a length of film tube is furled about the film tube magazine. The continuous liner system 440 may unfurl a portion of the length of film tube from the film tube magazine 441, and the unfurled portion of the length of film tube may be secured to a mouth of a destination container to form a sealed passage through the length of film tube leading from the module opening 410 to the mouth of the destination container. When all the desired materials are dispensed, the continuous liner system 440 may be operated to cut, crimp and seal the opening of the drum liner.

According to embodiments of the present invention as illustrated in FIG. 4C, a containment module 400 may be a split valve containment module. According to a split valve containment module embodiment of the present invention, a passage member 451 may be secured below the module opening 410 of the containment module 400, and a valve member 452 having a closed configuration and an opened configuration may be releasably secured to the mouth of the destination container. While the valve member 452 is in a closed configuration, a lower mouth of the passage member 451 may be docked with the valve member 452 such that the valve member 452 forms a seal over the lower mouth of the passage chamber 451. The valve member 452 may then be placed in an opened configuration to release the seal over the lower mouth of the passage member 451. While the valves of the active valve module and the passive valve modules are opened, materials dispensed through the containment module 400 may pass through the passage member 451 and the valve member 452 into the destination container.

According to a split valve containment module embodiment of the present invention, the passage member 451 may be a rigid member, such as a funnel, or a non-rigid member, such as a bag. The passage member 451 and the valve member 452 may separately provide two split valve members that are joined to form a valve mechanism when the passage member 451 is docked with the valve member 452. The valve mechanism may maintain the seal over the lower mouth of the passage member 451 while the valve mechanism is closed, and may release the seal over the lower mouth of the passage member 451 while the valve mechanism is open. The valve mechanism may be closed while the valve member 452 is in a closed configuration, and opened while the valve member 452 is in an opened configuration. A passage member 451 and valve member 452 that join to form a valve mechanism as provided by embodiments of the present invention may be a split valve system manufactured by Ezi-Dock or by ChargePoint.

According to embodiments of the present invention as illustrated in FIG. 4D, a containment module 400 may be an in-floor charging containment module. According to an in-floor charging containment module embodiment of the present invention, a floor passage 450 is secured to the module opening 410 of the module surface member 420. The floor passage 450 may have a bottom mouth which connects to an opening in a ground surface which connects to a process vessel under the ground surface.

According to embodiments of the present invention as illustrated in FIG. 4E, a containment module 400 may be a vacuum conveyance containment module. According to a vacuum conveyance containment module embodiment of the present invention, a vacuum passage 460 is secured to the module opening 410 of the module surface member 420, and a vacuum nozzle 461 connects the vacuum passage 460 to a vacuum process vessel.

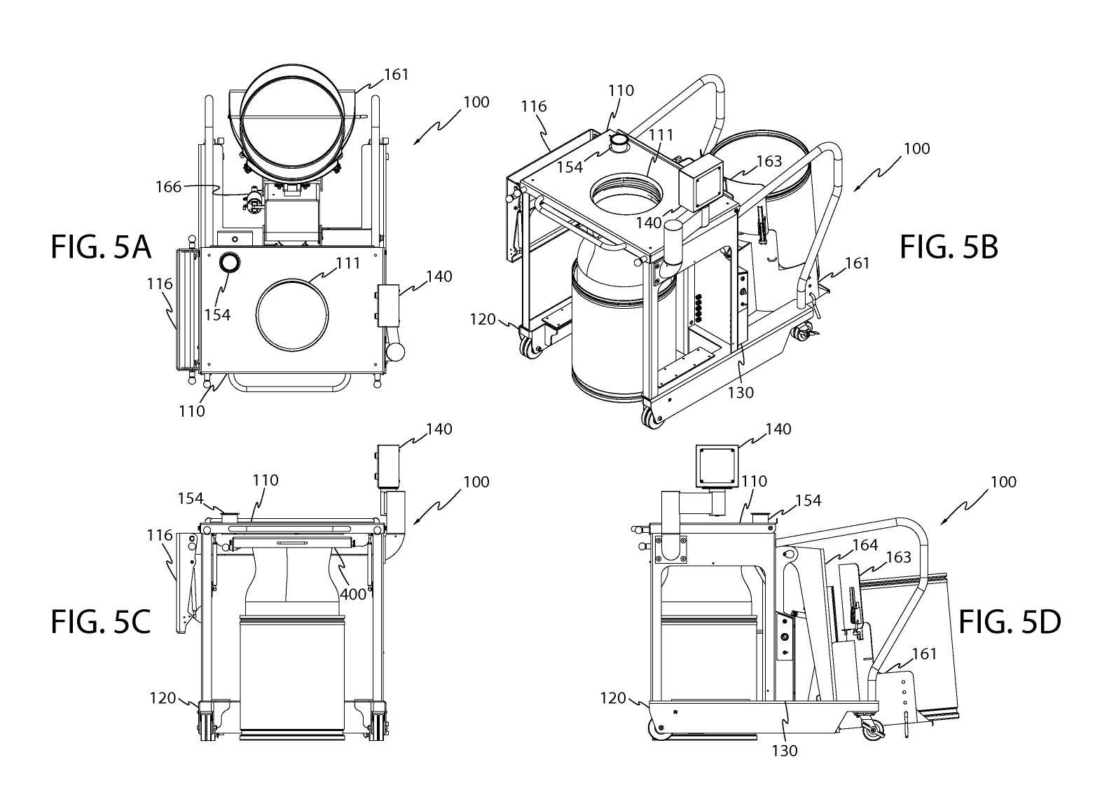

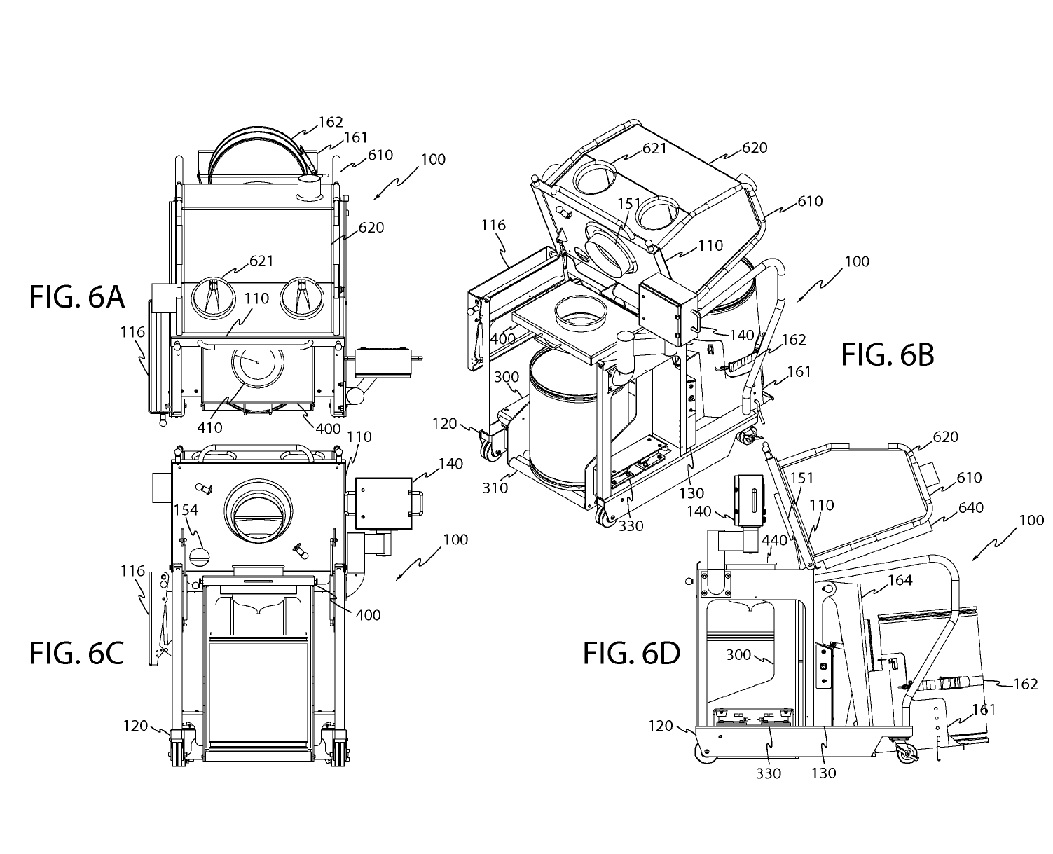

According to some embodiments of the present invention, a destination container may be a drum or hopper as illustrated in FIGS. 5B, 5C, 5D, 6B, 6C, and 6D, and may be lined with a container liner extensible from the mouth of the destination container, as illustrated in FIGS. 5B, 5C, and 5D.

According to embodiments of the present invention, the destination container may be a bottle. Handles may be releasably secured or permanently secured to the destination container. The destination container may be compatible with a pressurization system as known in the art for handling of wet and dry materials or for aseptic processing. A drum liner may be releasably secured to the mouth of the destination container using any suitable clamp, such as a band clamp. A seal and cap may be releasably secured to the destination container. According to a split valve containment module embodiment of the present invention, a destination container that is a bottle may be a charge bottle manufactured by Ezi-Dock or by ChargePoint.

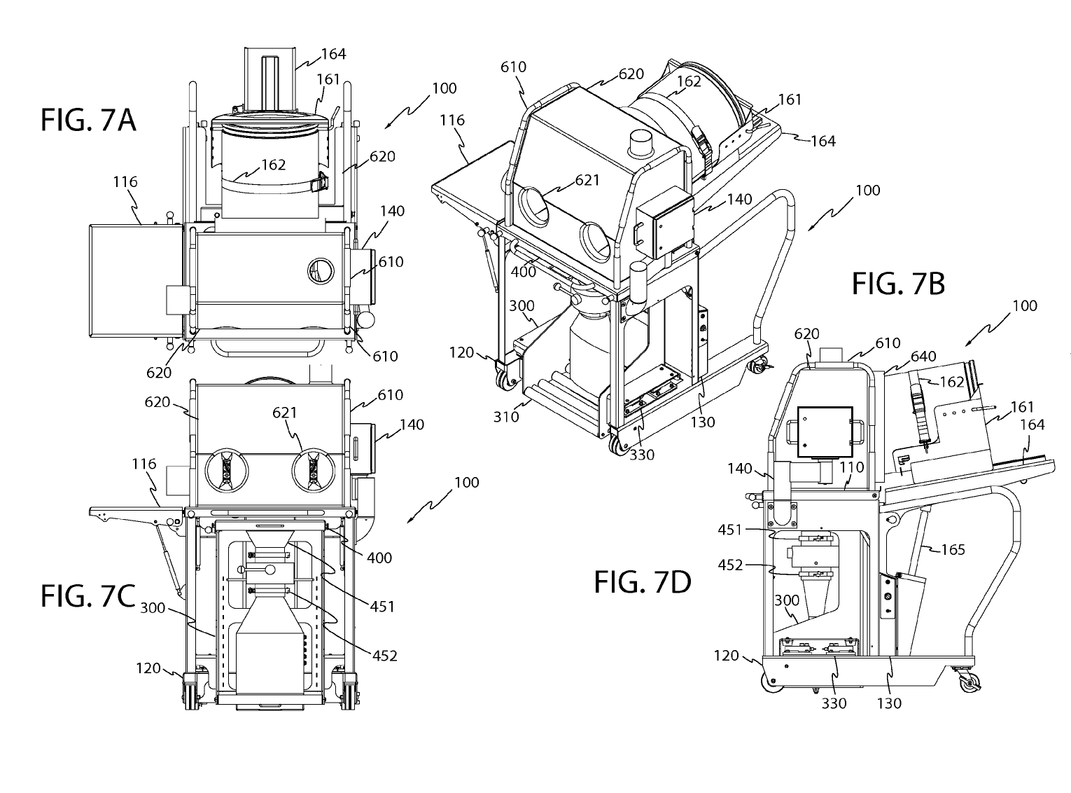

According to embodiments of the present invention, the destination container may be a bag as illustrated in FIGS. 7B and 7C. A handle may be removably secured to the bottom of the destination container to provide structural rigidity to the destination container so as to facilitate handling. A drum liner may be releasably secured to the mouth of the destination container using any suitable clamp, such as a tri-clamp. A seal and cap may be releasably secured to the destination container. According to a split valve containment module embodiment of the present invention, a destination container that is a bag may be a charge bag manufactured by Ezi-Dock or by ChargePoint.

Some embodiments of the present invention further provide the base frame 100 with a vibratory screener assembly. A vibratory screener assembly may be attached to the underside of the table member 110, and a destination container may be placed within the clearance 112. In such configurations, solid matter may be conveyed through the opening 111 of the table member 110 and through the vibratory screener assembly to be collected in the destination container. A vibratory screener assembly may be composed of a cylindrical chamber provided with a vertical passage through the top and bottom of the cylindrical chamber, and having a screen interposed between the top and bottom of the cylindrical chamber. A vibratory screener assembly may further include a motor that is integrated with the cylindrical chamber to induce vibrations. The motor may be in connection to the power output connection of the control box 130 so as to draw power from the power source. It will be appreciated by persons of ordinary skill in the art that a vibratory screener assembly may combine a cylindrical chamber, a screen, and a motor in various known configurations to control the flow of solid matter through the cylindrical chamber while the motor is activated. It will be further appreciated by persons of ordinary skill in the art that a vibratory screener assembly may be attached to a table member 110 in conjunction with a suspension system, which may absorb the force of vibrations induced by the powered motor.

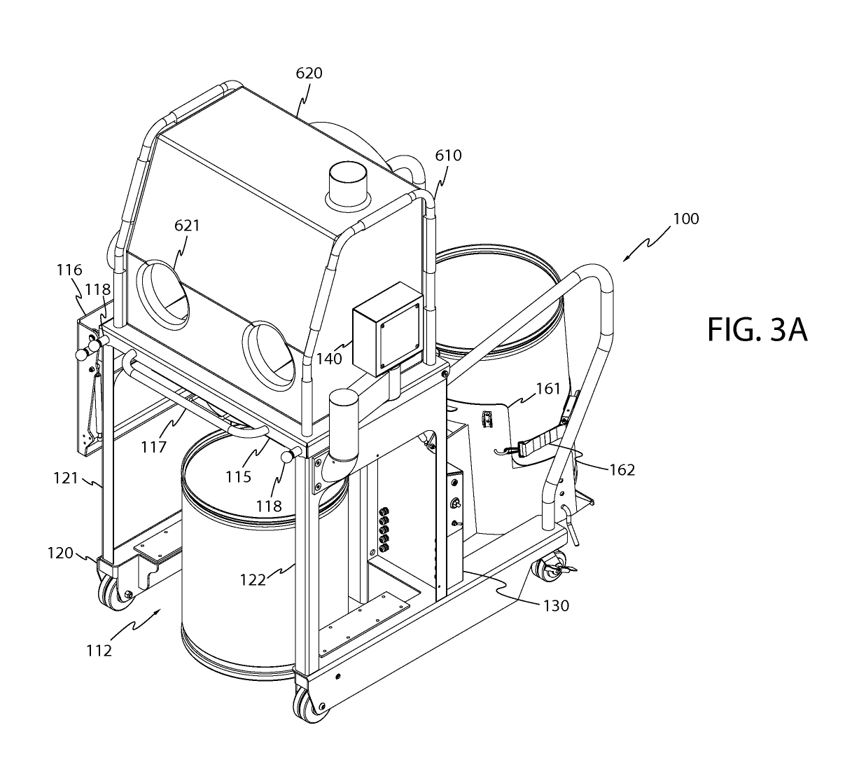

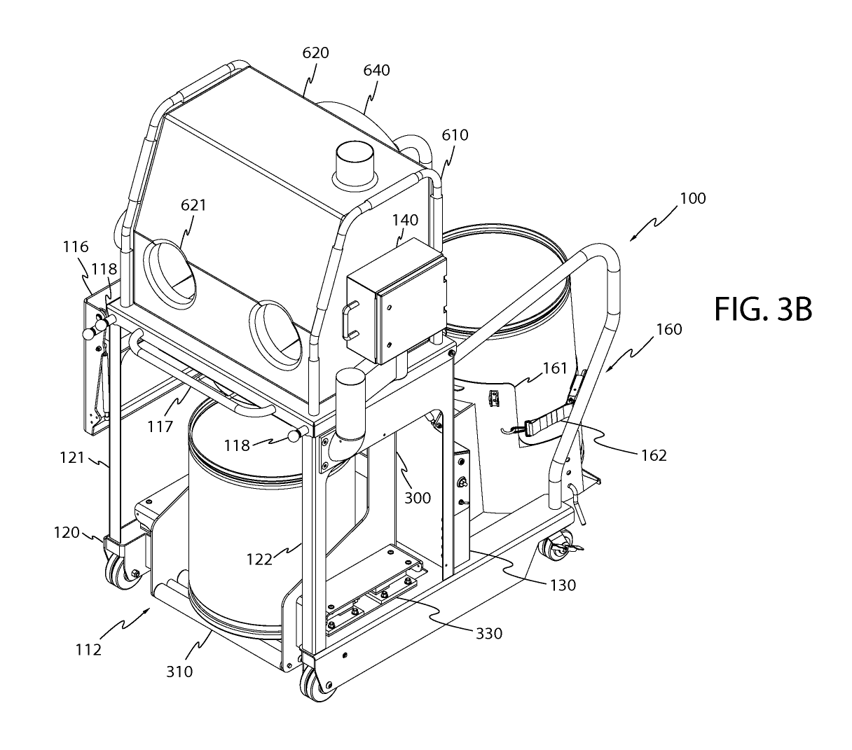

According to embodiments of the current invention as illustrated in FIGS. 3A, 3B, 6A through 6D, and 7A through 7D, a flexible isolator module 600 may be installed over the table member 110. The flexible isolator module 600 provides an isolator frame 610, where the base of the isolator frame 610 is removably securable to the table member 110 by fasteners. The isolator frame 610 may support mounting isolating film, such as by adherence between a hook-and-loop fastener, to separate the interior space of the flexible isolator module 600 from the exterior space. Isolating film may, for example, be mounted in the form of a glove bag 620 having at least one handling member 621 inset. A handling member 621 may be a glove member allowing a human operator to place a hand within the glove member to manipulate objects within the isolator frame 610. A side of the isolator frame 610 supports a feed in sleeve 630 of the glove bag 620. The back of the isolator frame 610 supports a charge port 640 of the glove bag 620. A discharge port 650 of the glove bag 620 inserts through the opening 111 of the table member 110. According to embodiments of the present invention as illustrated in

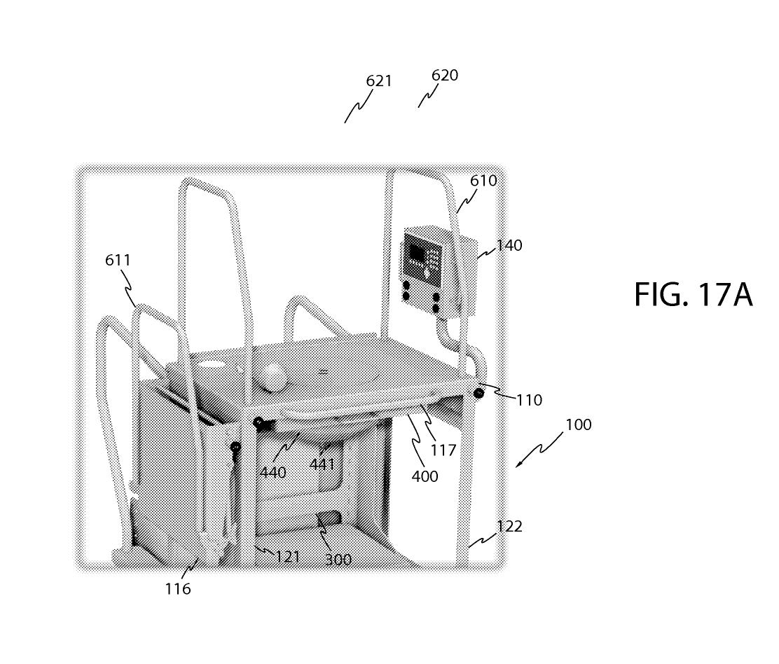

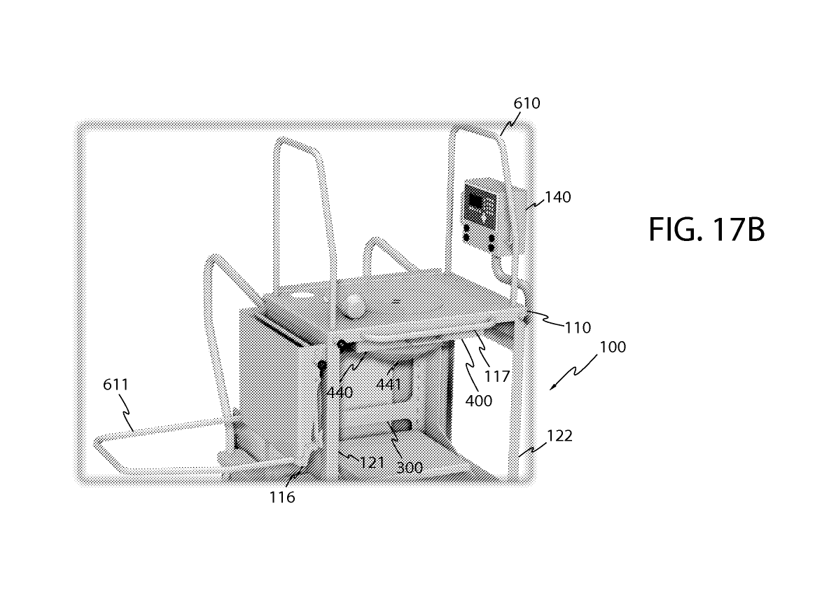

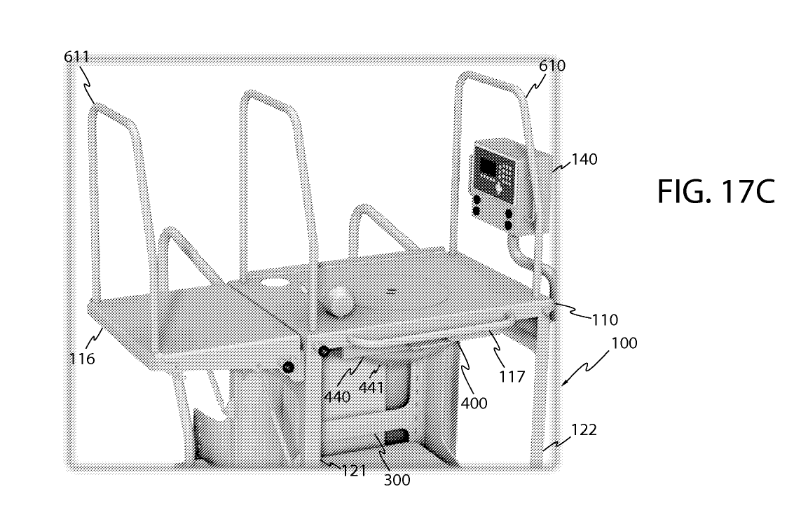

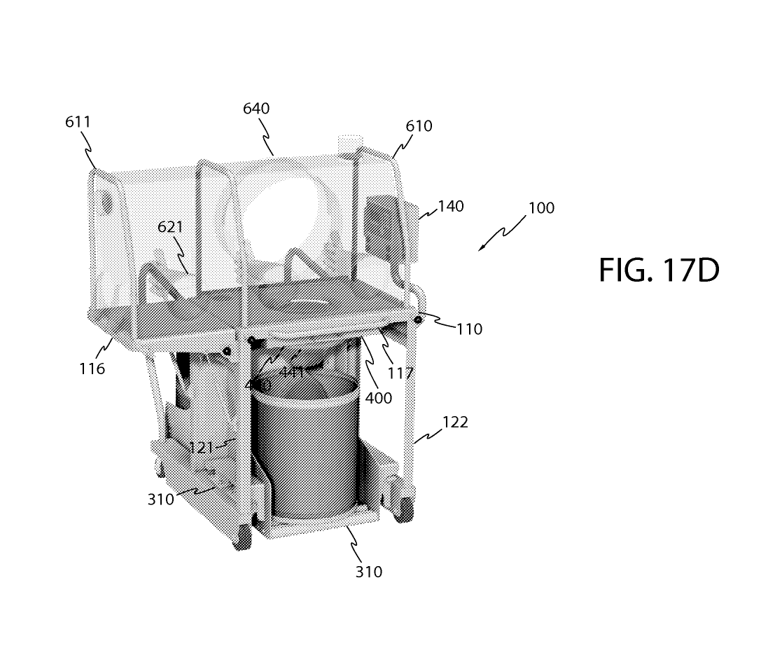

FIGS. 17A through 17D, a side table 116 may provide an isolator frame extension 611. The isolator frame extension 611 may be pivoted into a folded orientation against the side table 116 and a raised orientation upright from the side table 116. In either orientation, the isolator frame extension 611 may be secured in place by releasable fasteners such as pull pins. The releasable fasteners may be released to allow the isolator frame extension 611 to pivot between orientations. While the side table 116 is in a level orientation and the isolator frame extension 611 is in a raised orientation, the isolator frame 610 in conjunction with the isolator frame extension 611 may support an elongated glove bag 620 providing additional handling members 621.

According to embodiments of the current invention as illustrated in FIGS. 3B, 5A through 5D, 6A through 6D, and 7A through 7D, a glove bag 620 may further provide a filter port which may be connected to a nitrogen purge system. An elongated glove bag 620 may provide more than one filter port. A nitrogen purge system may be mounted to the base frame 100 and may be in connection to the power output connection of the control box 130 so as to draw power from the power source. The nitrogen purge system may be operated to regulate the relative humidity within the flexible isolator.

Embodiments of the present invention may combine a base frame 100, a receiving module 300, a containment module 400, a vibratory screener assembly, a flexible isolator module 600, a nitrogen purge system, and a weighing system in various modular configurations. Each modular configuration may be configured with any embodiments of the containment module 400.

A modular configuration according to embodiments of the present invention may be a standard containment configuration as illustrated in FIG. 2A, wherein a base frame 100 is configured with a containment module 400; may be optionally configured with a side table 116; may be optionally configured with a receiving module 300; and may be optionally configured with a vibratory screener assembly.

A modular configuration according to embodiments of the present invention may be a standard containment configuration having a weighing system as illustrated in FIG. 2B and FIGS. 5A through 5D, wherein a base frame 100 is configured with a receiving module 300, a weighing system, and a containment module 400; and may be optionally configured with a side table 116.

A modular configuration according to embodiments of the present invention may be a high containment configuration as illustrated in FIG. 2C, wherein a base frame 100 is configured with a containment module 400 and a flexible isolator module 600; may be optionally configured with a side table 116; may be optionally configured with a receiving module 300; may be optionally configured with a vibratory screener assembly; and may be optionally configured with a nitrogen purge system.

A modular configuration according to embodiments of the present invention may be a high containment configuration having a weighing system as illustrated in FIG. 2D, FIGS. 6A through 6D, and FIGS. 7A through 7D, wherein a base frame 100 is configured with a receiving module 300, a load cell 330, a weighing system, and a containment module 400; may optionally be configured with a side table 116; may be optionally configured with a vibratory screener assembly; and may be optionally configured with a nitrogen purge system.

In operation, by operating a container tipper 160 to elevate a supply container, solid matter from the supply container may be conveyed through the table member 110 into a destination container. Embodiments of the present invention may provide an open transfer method and a closed transfer method.

According to an open or a closed transfer method of the present invention, the base frame 100 is rendered stationary on a ground surface. According to embodiments of the present invention where the base member 120 is a stationary installation base member, the base member 120 may be fixed to the ground surface to render the base frame 100 stationary. According to embodiments of the present invention where the base member 120 is a mobile installation base member, a locking member of the base member 120 may be engaged to fix the base member 120 to the ground surface.

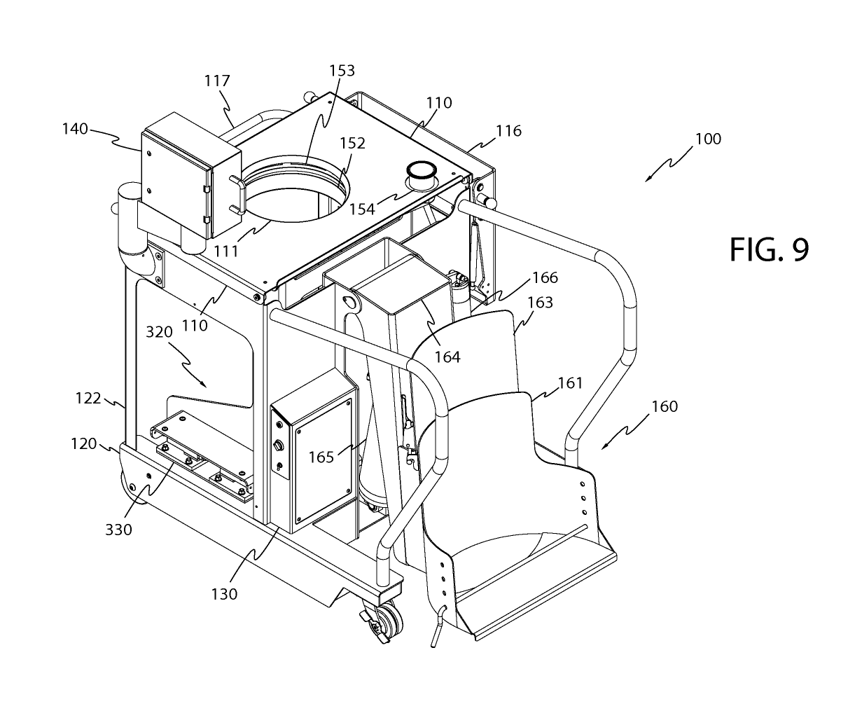

According to an open or a closed transfer method of the present invention, a power source is connected to the control box 130 by the power input connection of the control box 130 as illustrated in FIG. 9, and the operation switch of the control box 130 may be activated. The power source may be a fluid power source such as a pneumatic power generator or an electric-hydraulic power generator.

According to an open transfer method of the present invention, a ventilation sleeve 150 may be fastened to the underside of the table member 110. The ventilation sleeve 150 may be fastened to the table member 110 while the front edge 115 of the table member 110 is released from the first riser 121 and the second riser 122 and the table member 110 is raised to an upright position.

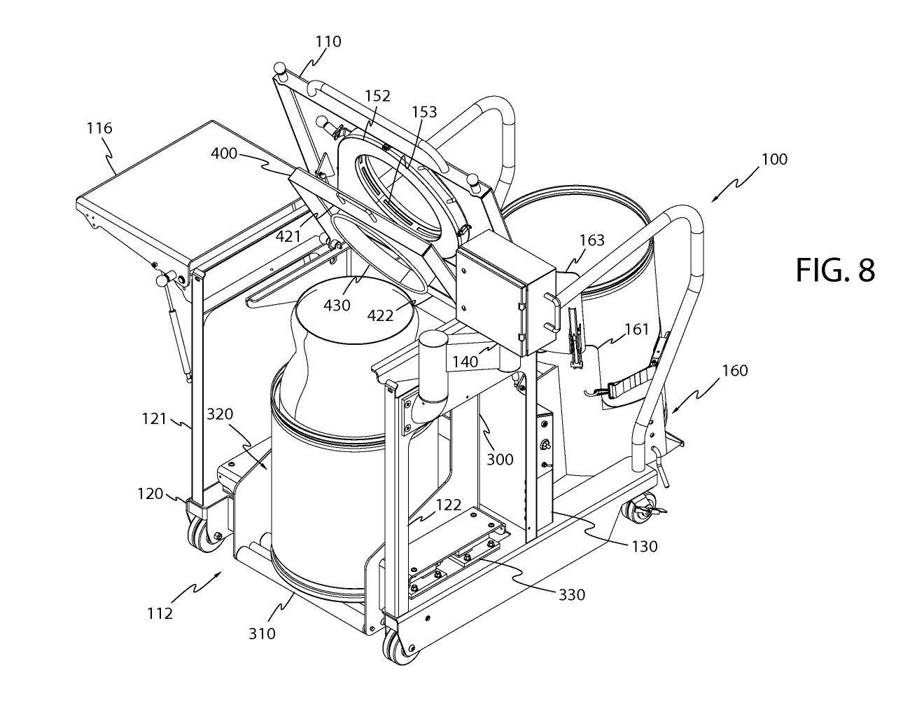

According to an open or a closed transfer method of the present invention, a containment module 400 is fastened to the base frame 100 beneath the table member 110 such that the module surface member 420 is suspended over the clearance 112 by the base frame 100. According to an open transfer method of the present invention, a containment module 400 may be an open transfer containment module. According to a closed transfer method of the present invention, a containment module 400 may be any containment module as described herein. The containment module 400 may be fastened to the table member 110 while the front edge 115 of the table member 110 is released from the first riser 121 and the second riser 122 and the table member 110 is raised to an upright position, as illustrated in FIG. 8.

According to a closed transfer method of the present invention, an isolator frame 610 may be secured to the table member 110. The isolator frame 610 may be secured to the table member 110 while the table member 110 is lowered and the front edge 115 of the table member 110 is fastened to the first riser 121 and the second riser 122. If the base frame 100 provides a side table 116 having an isolator frame extension 611, the side table 116 may be pivoted and secured in a level orientation and the isolator frame extension 611 may be pivoted and secured in a raised orientation.

According to a closed transfer method of the present invention, a glove bag 620 may be mounted to the isolator frame 610 while the isolator frame 610 is secured to the table member 110, such that each handling member 621 is accessible from the front of the isolator frame 610. If the base frame 100 provides a side table 116 having an isolator frame extension 611, an elongated glove bag 620 may be mounted to the isolator frame 610 and the isolator frame extension 611 in conjunction. A discharge port 650 of a glove bag 620 may be inserted through the opening 111 of the table member 110 while the glove bag 620 is mounted to the isolator frame 610.

According to a closed transfer method of the present invention, a continuous liner containment module embodiment of the present invention, a continuous liner system 440 is secured through the module opening 410 of the module surface member 420.

According to an open or a closed transfer method of the present invention, a supply container is loaded onto the cradle 161 of the container tipper 160. A cradle extension 163 may be installed onto the cradle 161 before the supply container is loaded onto the cradle 161. A restraint 162 may be releasably secured across the cradle 161 after the supply container is loaded onto the cradle 161.

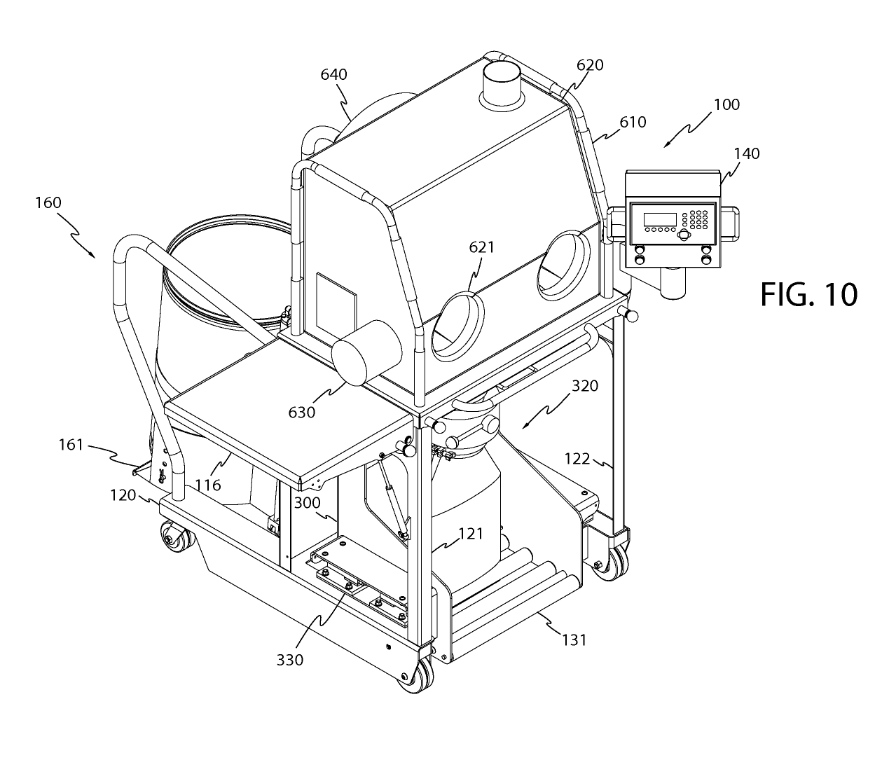

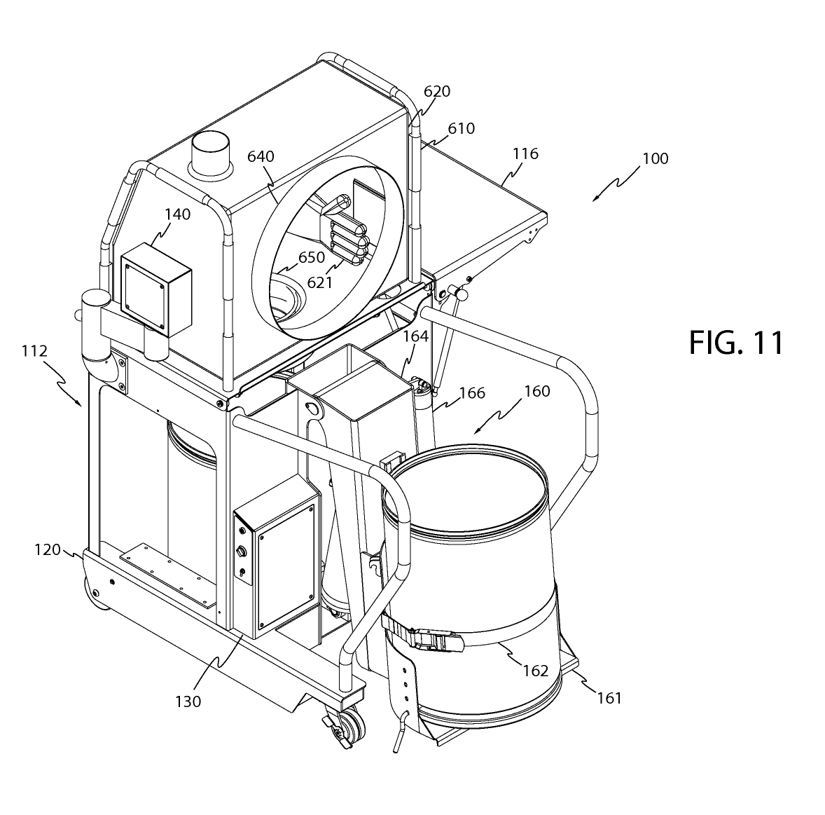

According to a closed transfer method of the present invention, a supply container may be instead loaded onto the side table 116. A side table 116 may be pivoted to a level orientation from a lowered orientation. To load the supply container onto the side table 116, the side table 116 is placed in a level position, and the supply container is placed onto the side table 116 as illustrated in FIG. 10.

According to an open or closed transfer method of the present invention, a destination container may be positioned with respect to the clearance 112. According to an open transfer method of the present invention, the destination container is set in the clearance 112 while the front edge 115 of the table member 110 is released from the first riser 121 and the second riser 122 and the table member 110 is raised, and while the containment module 400 is raised. According to the a closed transfer method of the present invention, the destination container may be set in the clearance 112 while the table member 110 is lowered and the front edge 115 of the table member 110 is released from the first riser 121 and the second riser 122, and while the containment module 400 is lowered. If the base frame 100 is configured with a receiving module 300, the destination container may be set on the receiving module 300 by the roller conveyor 310.

If the containment module 400 is an in-floor charging containment module or a vacuum conveyance containment module, the destination container may be stationary and the base frame 100 may be positioned suitably in proximity to the destination container.

According to a closed transfer method of the present invention, if the supply container is loaded onto the cradle 161, a connection is established from the mouth of the supply container to the charge port 640 of the glove bag 620. The isolating film material of the charge port 640 may be extended and secured to the mouth of the supply container. An internal liner may be secured from the charge port 640 to the opening 111 to establish a passage from the charge port 640 to the opening 111. The internal liner may be secured by manual manipulation using a handling member 621. If installed, a cradle extension 163 may block securing the charge port 640 to the mouth of the supply container; if so, the cradle extension 163 may be removed prior to this step.

According to a closed transfer method of the present invention, if the supply container is loaded onto the cradle 161, a connection is established from the mouth of the supply container to the feed in sleeve 630. To engage the supply container with the feed in sleeve 630, the isolating film material of the feed in sleeve 630 is secured to the mouth of the supply container. An internal liner may be secured from the feed in sleeve 630 to the opening 111 to establish a passage from the feed in sleeve 630 to the opening 111. The internal liner may be secured by manual manipulation using a handling member 621.

According to an open or a closed transfer method of the present invention, a passage is established from the opening 111 to the interior of the destination container. According to an open transfer method of the present invention, the destination container is lined with a container liner having an open end, and a passage is established from the mouth of the destination container to the opening 111 by removably securing the open end of the container liner to the lower ring 430 of the containment module 400, as illustrated in FIG. 8. According to a closed transfer method of the present invention, if the containment module 400 is a continuous liner containment module, an unfurled portion of a length of film tube from the film tube magazine 441 may be lowered into the destination container to form a passage through the length of film tube leading from the module opening 410 to the mouth of the destination container. If the containment module 400 is a split valve containment module, a passage member 451 may be secured below the module opening 410 of the containment module 400, securing a valve member 452 to the mouth of the destination container, and docking a lower mouth of the passage member 451 with the valve member 452 such that the valve member 452 forms a sealed enclosure around the lower mouth of the passage chamber 451. If the containment module 400 is an in-floor charging containment module, a floor passage 450 may be secured to the module opening 410 of the module surface member 420, and the bottom mouth of the floor passage 450 may be connected to an opening in a ground surface which connects to a process vessel under the ground surface. If the containment module 400 is a vacuum conveyance containment module, a vacuum passage 460 may be secured to the module opening 410 of the module surface member 420, and a vacuum nozzle 461 connected to the vacuum passage 460 may be connected to a vacuum process vessel.

According to an open or a closed transfer method of the present invention, an operator interface 140 may be laterally turned to face the human interface device in a frontal, side, or rearward direction.

According to an open or a closed transfer method of the present invention, the operator interface 130 is manipulated to send a command signal through the control circuit to the powered actuator 165 to cause the powered actuator 165 to raise the pivoting arm 164 to shift the cradle 161 to an uptilted position. The cradle 161 may then be slid along the pivoting arm 164 to laterally move the mouth of the supply container over the opening 111 of the table member 110. According to a closed transfer method of the present invention, the supply container may be partially moved into the interior space of the flexible isolator module 600.

According to an open or a closed transfer method of the present invention, an air conductor connected to an HVAC system may be connected to the exhaust port 154 of the ventilation sleeve 150 as illustrated in FIG. 9.

According to an open or a closed transfer method of the present invention, if the modular configuration of the present invention is a standard containment configuration having a weighing system or a high containment configuration having a weighing system, next, the weighing system may be operated using the operator interface 140 to set a tare weight.

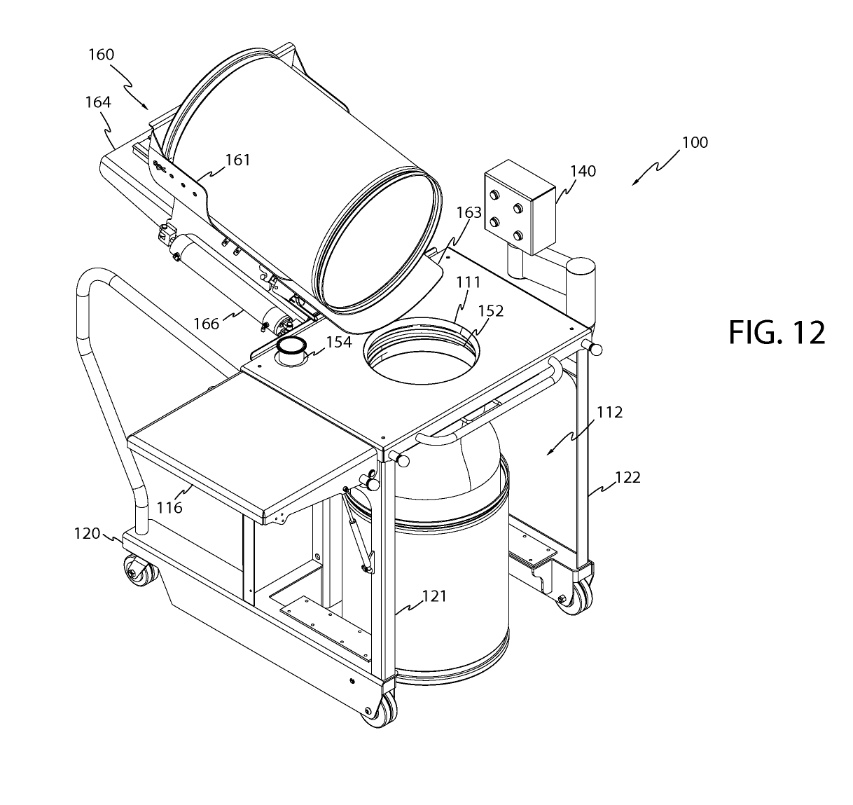

According to an open or a closed transfer method of the present invention, next, solid matter from the supply container is transferred to the destination container. According to an open transfer method of the present invention, the contents of the supply container may be dispensed from the supply container through the opening 111 into the mouth of the destination container, as illustrated in FIG. 12. According to a closed transfer method of the present invention, solid matter from the supply container may be guided through either an internal liner connecting the feed in sleeve 630 and the opening 111 or an internal liner connecting the charge port 640 and the opening 111. Solid matter passing through the opening 111 then falls through the passage connecting the opening 111 and the mouth of the destination container. If the containment module 400 is a split valve containment module, the valve mechanism may be opened prior to transferring solid material by placing the valve member 452 in an opened configuration. The transfer of solid matter from the supply container to the destination container may be guided by manual manipulation using a handling member 621.

While transferring solid matter from the supply container into the destination container, an HVAC system in connection with the exhaust port 154 may be operated to provide ventilation through the ventilation sleeve 150, and, according to a closed transfer operation method of the present invention, the nitrogen purge system may be operated to regulate the humidity within the interior space of the flexible isolator module 600.

According to an open or a closed transfer method of the present invention, if the modular configuration of the present invention is a standard containment configuration having a weighing system or a high containment configuration having a weighing system, next, the weighing system may be operated using the operator interface 140 to measure the weight of the solid matter transferred into the destination container and record a measured weight in the memory of the operator interface 140.

According to a closed transfer method of the present invention, the supply container may be disengaged either from the feed in sleeve 630 or from the charge port 640. The isolating film material connecting the feed in sleeve 630 and the opening 111 or connecting the charge port 640 and the opening 111 may be cut and crimped to seal the opening of the supply container.

According to an open or a closed transfer method of the present invention, the cradle 161 may be slid along the pivoting arm 164 to laterally move the supply container away from over the table member 110. The operator interface 130 may then be manipulated to send a command signal through the control circuit to the powered actuator 165 to cause the powered actuator 165 to lower the pivoting arm 164 to shift the cradle 161 to an upright position.

According to an open or a closed transfer method of the present invention, the supply container may be unloaded either from the side table 116 or from the cradle 161.

According to a closed transfer method of the present invention, the container liner of the destination container may be disengaged from the lower ring 430 of the containment module 400. The container liner may be cut and crimped to seal the opening of the destination container.

According to an open or a closed transfer method of the present invention, the destination container may be removed from the base frame 100. According to an open transfer method of the present invention, the container liner of the destination container is removed from the opening 430 of the lower ring and is cut and crimped. According to a closed transfer method of the present invention, if the containment module 400 is a continuous liner containment module, the length of film tube is retracted from the interior of the destination container and is cut and crimped, and the destination container is sealed. Alternately, if the containment module 400 is a split valve containment module, the valve mechanism is closed by placing the valve member 452 in a closed configuration, and the passage member 451 is undocked from the valve member 452. According to an open or a closed transfer method of the present invention, the destination container is then removed from the clearance 112.

If the containment module 400 is an in-floor charging containment module or a vacuum conveyance containment module, the floor passage 450 or the vacuum passage 460 may be disconnected from the destination container and the destination container may be closed.

According to a closed transfer operation method of the present invention, next, the glove bag 620 may be cut and crimped and removed from the isolator frame 610.

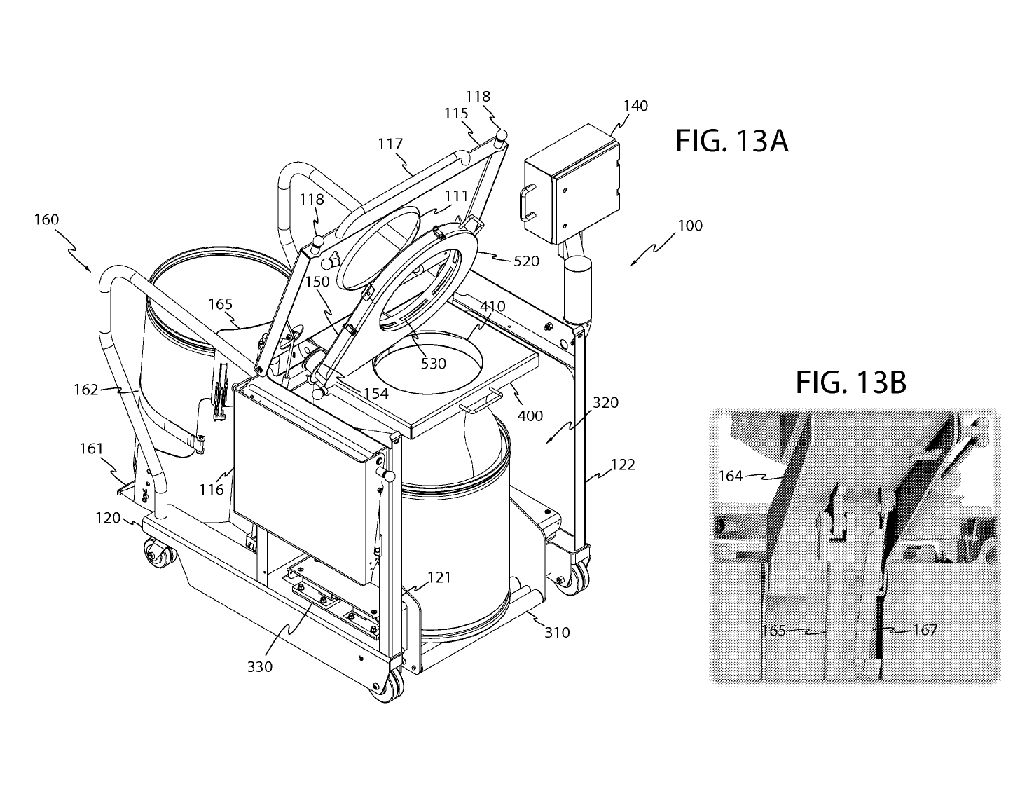

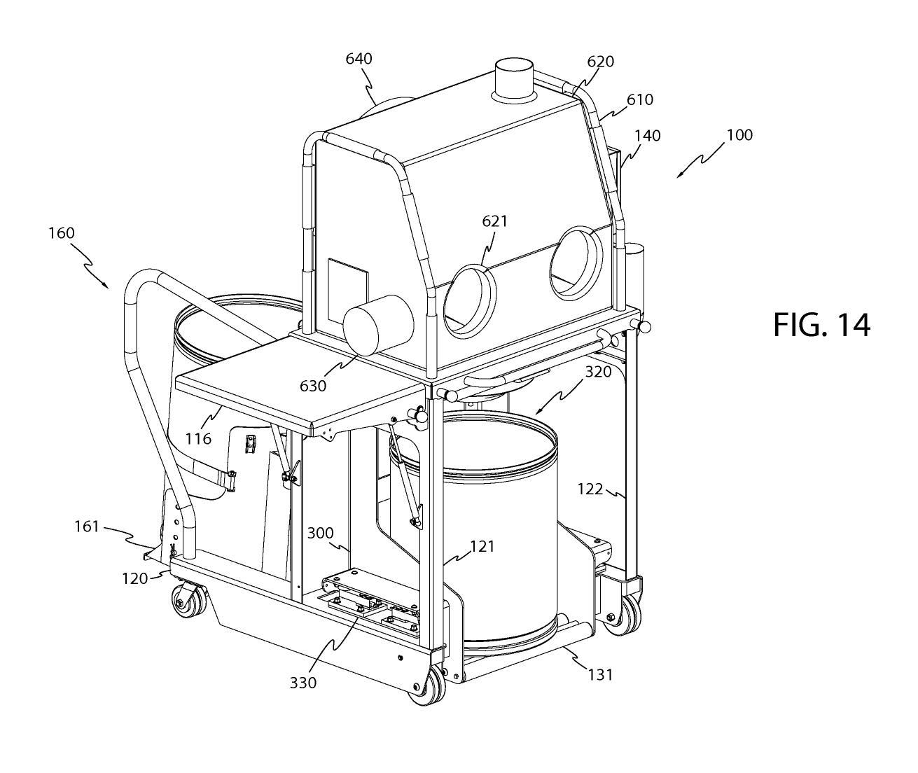

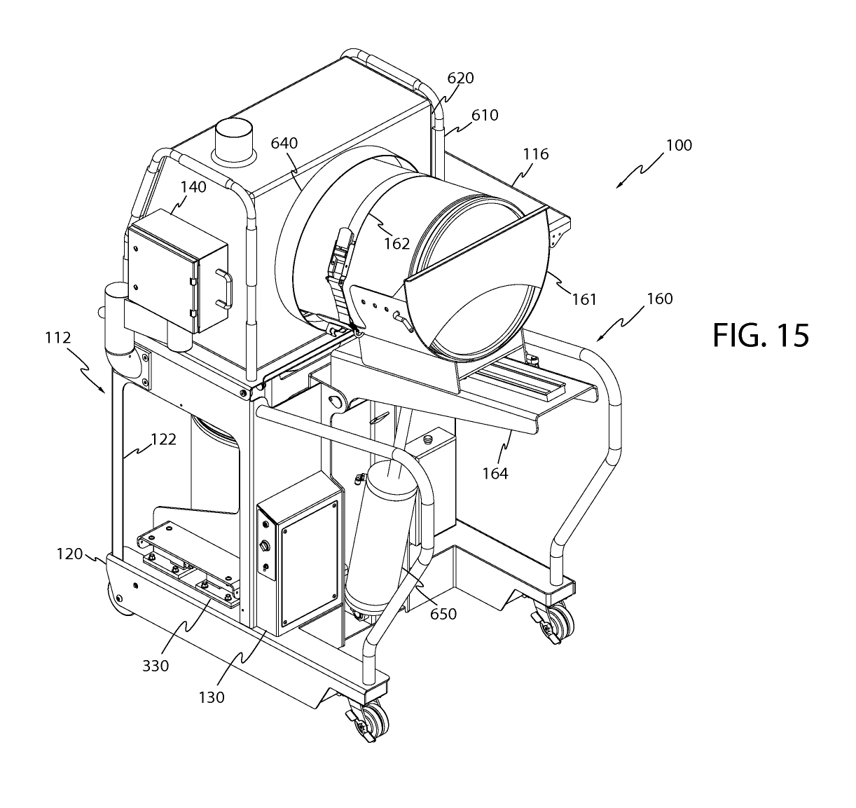

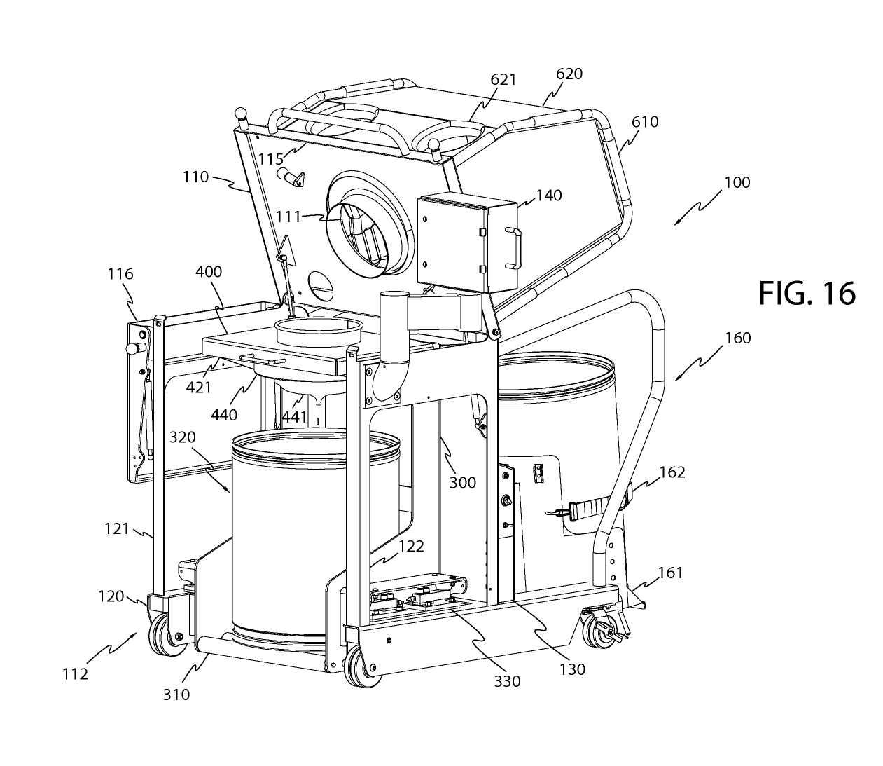

Embodiments of the present invention generally provide a disassembly method. The HVAC system may be disconnected from the exhaust port 154. The container tipper 160 may be operated to raise the pivoting arm 164. The cradle 161 may be slid towards the table member 110. The operation switch of the control box 130 may be set to maintenance mode and the control box 130 connections may be drained. While power is not provided from the power source, the pivoting arm 164 may be held suspended by engaging a mechanical stop 167 under the pivoting arm 164 as illustrated in FIG. 13B, or the pivoting arm 164 may be lowered and the container tipper 160 connections may be drained. After drainage of the control box 130 and the container tipper 160 connections is complete, the operation switch may be set to shutdown mode cutting off flow from the power source. The front edge 115 of the table member 110 may be released from the first riser 121 and the second riser 122 and raised. The ventilation sleeve 150 may be removed from the table member 110 as illustrated in FIG. 13A, and the containment module 400 may be removed from the base frame 100. In this state, suitable maintenance and cleaning procedures may be performed on the base frame 100.

While particular elements, embodiments, and applications of the present invention have been shown and described, the invention is not limited thereto because modifications may be made by those skilled in the art, particularly in light of the foregoing teaching. It is therefore contemplated by the application to cover such modifications and incorporate those features which come within the spirit and scope of the invention.

What is claimed is:

1. A system comprising:
a base frame 100 comprising a table member 110, a base member 120, and an operator interface 140; and
a container tipper 160 secured to the base frame 100, comprising a cradle 161, a pivoting arm 164, and a powered actuator 165;
wherein the table member 110 is suspended by the base member 120 over a clearance 112;
wherein an opening 111 through the table member 110 opens over the clearance 112;
wherein the powered actuator 165 is configured to shift the cradle 161 to an uptilted position by elevating the pivoting arm 164, and to shift the cradle 161 to an upright position by lowering the pivoting arm 164; and
wherein the operator interface 140 provides a control manipulable to send a command signal to the powered actuator 165 causing the powered actuator 165 to raise the pivoting arm 164; and
wherein the operator interface 140 provides a control manipulable to send a command signal to the powered actuator 165 causing the powered actuator 165 to lower the pivoting arm 164.

2. The system of claim 1, wherein the cradle 161 is slidable along a length of the pivoting arm 164.

3. The system of claim 1, further comprising a receiving module 300 attached to the base frame 100 within the clearance 112;
wherein the receiving module 300 comprises a roller conveyor 310 and an enclosure 320.

4. The system of claim 3, wherein the receiving module 300 further comprises a load cell 330;
wherein the load cell 330 measures a force exerted by an object held by the receiving module 300;
wherein the load cell 330 translates the measured force to a weight measurement value;
wherein the load cell 330 transmits a display signal to the operator interface 140 causing the operator interface 140 to display the weight measurement value.

5. The system of claim 1, further comprising a containment module 400 attached to the base frame 100 beneath the table member 110, wherein the containment module 400 comprises a module opening 410 through a module surface member 420.

6. The system of claim 5, further comprising a lower ring 430 encircling the module opening 410 at the underside of the module surface member 420.

7. The system of claim 5, further comprising a continuous liner system 440 secured through the module opening 410, and a film tube magazine 441 loaded onto the continuous liner system 440.

8. The system of claim 5, further comprising a passage member 451 secured below the module opening 410, the passage member being dockable with a valve member 452 such that the valve member 452 forms a seal over a lower mouth of the passage chamber 451.

9. The system of claim 5, further comprising a flexible isolator module 600, the flexible isolator module 600 comprising an isolator frame 610 secured to the table member 110.

10. The system of claim 9, further comprising a side table 116, the side table 116 comprising an isolator frame extension 611.

11. The system of claim 9, further comprising a glove bag 620 mounted to the isolator frame 610, the glove bag 620 having a handling member 621 inset.

12. The system of claim 11, wherein the glove bag further comprises a filter port which receives a connection to a nitrogen purge system.

13. A method comprising:
rendering a base frame 100 stationary on a ground surface;
fastening a containment module 400 to the base frame 100 beneath a table member 110 of the base frame 100 such that the containment module 400 is suspended over a clearance 112 beneath the table member 110;
loading a supply container onto the base frame 100;
positioning a destination container with respect to the clearance 112;
establishing a passage from an opening 111 through the table member 110 to the interior of the destination container; and
transferring solid matter from the supply container to the destination container.

14. The method of claim 13, wherein the supply container is loaded onto a cradle 161 of a container tipper 160 comprising a pivoting arm 164 and a powered actuator 165; and
further comprising operating the powered actuator 165 to raise the pivoting arm 164 to shift the cradle 161 to an uptilted position.

15. The method of claim 14, further comprising sliding the cradle 161 along the pivoting arm 164 to move a mouth of the supply container over the opening 111.

16. The method of claim 14, further comprising:
securing an isolator frame 610 to the table member 110;
mounting a glove bag 620 to the isolator frame 610;
establishing a connection from a mouth of the supply container to the glove bag 620.
